(19) United States
(12) Patent Application Publication
(10) Pub. No.: US 2026/0161387 A1
(43) Pub. Date: Jun. 11, 2026

(54) GOVERNANCE FOR CODE GENERATION BY LARGE LANGUAGE MODELS

(71) Applicant: INTERNATIONAL BUSINESS MACHINES CORPORATION, Armonk, NY (US)

(72) Inventors: Romelia H. FLORES, Keller, TX (US); Christopher LAZZARO, Austin, TX (US); Rubayat Mossharaf KHAN, Leander, TX (US)

(21) Appl. No.: 18/973,296

(22) Filed: Dec. 9, 2024

(51) Int. Cl. G06F 8/70; G06F 3/0484; G06F 8/30

(52) U.S. Cl. CPC G06F 8/70; G06F 3/0484; G06F 8/30

(57) ABSTRACT

A computer-implemented method includes: generating one or more insights by analyzing metadata associated with a source code that has been deposited in a repository, the one or more insights being based on a portion of the source code that was generated using an artificial intelligence (AI) model; and generating one or more visualizations that are based on the one or more insights and that are configured to be displayed in a user interface of a user device.

### BACKGROUND

Aspects of the present invention relate generally to artificial intelligence (AI) and, more specifically, to generative AI risk management for enterprises.

Generative AI risk management involves addressing the potential risks and challenges associated with the use of generative AI systems in various domains including software development, data generation, and content generation.

### SUMMARY

In a first aspect of the invention, there is a computer-implemented method including: generating one or more insights by analyzing metadata associated with a source code that has been deposited in a repository, the one or more insights being based on a portion of the source code that was generated using an artificial intelligence (AI) model; and generating one or more visualizations that are based on the one or more insights and that are configured to be displayed in a user interface of a user device.

In another aspect of the invention, there is a computer program product comprising one or more computer-readable storage media, and program instructions stored on the one or more computer-readable storage media to perform operations comprising: generating one or more insights by analyzing metadata associated with source code that has been deposited in a repository, the one or more insights being based on one or more portions of the source code that were generated using one or more different artificial intelligence (AI) models, the metadata having been associated with the source code in an integrated development environment (IDE); and generating one or more dashboard visualizations that are based on the one or more insights and that are configured to be displayed in a user interface of a user device.

In another aspect of the invention, there is a computer system comprising a processor set, one or more computer-readable storage media, and program instructions stored on the one or more computer-readable storage media to cause the processor set to perform operations comprising: detecting one or more portions of source code that were generated using one or more different artificial intelligence (AI) models; associating metadata with the source code based on the detecting; generating one or more insights by analyzing the metadata, the one or more insights being based on the one or more portions of source code that were generated using the one or more different artificial intelligence (AI) models; and generating one or more dashboard visualizations that are based on the one or more insights and that are configured to be displayed in a user interface of a user device.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIGS. 3A and 3B show flowcharts of an exemplary method in accordance with aspects of the present invention.

FIG. 4 shows an exemplary visualization in accordance with aspects of the present invention.

FIG. 5 shows an exemplary visualization in accordance with aspects of the present invention.

FIG. 6 shows an exemplary visualization in accordance with aspects of the present invention.

FIG. 7 shows a flowchart of an exemplary method in accordance with aspects of the present invention.

### DETAILED DESCRIPTION

Aspects of the present invention relate generally to artificial intelligence (AI) and, more specifically, to generative AI risk management for enterprises. Generative AI tools have gained popularity among software developers for providing intelligent code suggestions and automating routine coding tasks. These tools leverage large language models (LLMs) trained on publicly available code repositories to generate code snippets and solutions, aiming to improve productivity and efficiency in software development. However, the use of generative AI in software development raises risks related to security vulnerabilities, compliance issues, code maintainability, and privacy concerns.

Statistics suggest that a significant portion of source code checked in by code developers is AI-generated and unmodified, accounting for approximately 40% of their contributions. Data indicates that these developers heavily rely on generative AI tools to produce code snippets and solutions for their projects. With a growing amount of source code being generated using generative AI tools, developers are typically just copying the AI-generated code and checking it in under their credentials. In these situations, a version control system can identify who checked in the source code (e.g., via the credentials of the human who is logged in and performs the check-in of the source code) but cannot ascertain whether the checked-in code was generated by a generative AI tool. That information does not currently exist but would be useful for senior developers to make an informed decision if they need to add additional measures before allowing this source code to be merged into a higher order branch.

Adding to this problem, reports suggest that approximately 40% of the AI-generated code is considered buggy and requires modifications by developers. Such issues could potentially lead to inefficiencies, increased debugging efforts, and even security vulnerabilities in software projects. It is expected that over time LLMs that are utilized as the foundation for generating code will refine themselves. However, tools do not currently exist to enable someone to gauge the level of risk based on the amount of code being generated by a generative AI tool.

Furthermore, the usage of AI-generated code also introduces legal and ethical implications. There have been discussions and debates surrounding open-source license claims against AI coding assistants. Additional problems arise in the areas of quality and security because generative AI outputs may contain inaccuracies, security vulnerabilities, and compliance violations, leading to legal and financial risks. Even further problems arise due to ethical and legal implications because the use of generative AI may introduce legal complexities, such as potential copyright infringement, loss of propriety information, and open source licensing claims, requiring organizations to balance risks with innovation rewards. Problems may also arise with concepts of bias and compliance because generative AI models may replicate biases present in the training data, posing challenges related to bias mitigation, compliance with regulations, and data privacy. Yet further problems may arise in the areas of code review and governance because the lack of transparency in generative AI systems raises concerns about code maintainability, privacy, and the need for comprehensive strategies to manage the risks posed by generative AI while ensuring responsible and secure use.

Implementations of the invention address these problems by providing systems and methods for a governance framework for managing risks associated with using generative AI for code generation. The governance framework in accordance with aspects of the invention provides enterprise users with real-time visualization of insights that are based on the percentage of a code that is AI-generated code versus human-generated code, the identification of the specific AI models used to generate the AI-generated code, and licensing information associated with the specific AI models used to generate the AI-generated code. Implementations include systems and methods that: generate the insights by analyzing metadata associated with source code that has been deposited in a repository, the insights being based on a portion of the source code that was generated using an artificial intelligence (AI) model; and generate dashboard visualizations that are based on the insights and that are configured to be displayed via a user interface of a user device.

Implementations of the invention determine proportions of code that are AI-generated versus human generated, generate insights based on the proportions, and generate visualizations based on the insights provide an improvement in the technical field of generative AI risk management. For example, such insights and visualizations provide engineering managers, who are responsible for overseeing the productivity of their developers, with substantial benefits by providing enhanced transparency and a deeper comprehension of the code that is executed across their current systems (e.g., development, staging, production, etc.). Furthermore, such insights and visualizations provide valuable advantages, such as enabling engineering managers to assess the risk associated with the volume of AI-generated code and the overall maturity of project generated code. Equally important, engineering developers tasked with fine-tuning the code can also benefit by using the insights and visualizations generated by implementations of the invention to gauge the code generation maturity, pinpointing potential areas of code for review based on prior generations. All of these benefits represent various improvements in the technical field of generative AI risk management.

As a result, enterprises that adopt the novel governance framework described herein will benefit from having a proper governance for using generative AI for code generation, thereby reducing their risks of exposure of using generating AI technologies. Additionally, implementations of the invention will help end users, such as license compliance officers, to ensure that the source code generated by the organization has minimal to negligible probability of getting into a dispute around intellectual property rights. Additionally, software engineering leadership teams that are responsible for adopting code generation AI models can use implementations of the invention to safely understand the risks associated with the AI models and make better informed decisions as part of the generative AI governance lifecycle.

In accordance with aspects of the present invention, methods and system provide a cross-project dashboard that interacts with a source code manager (SCM) repository using metadata associated with a source code to gather statistics for creation of an enterprise report of governance, auditing, and risk statistics related to AI provenance. An example of such statistics includes but is not limited to: percentage of lines of the source code that were generated by an AI model, with links to model governance (license restrictions, etc.); percentage of lines of the source code generated directly by an AI model without any modification by the developer; and risk levels associated with the AI models used to generate code included in the source code.

The cross-project dashboard, which may include the dashboard visualizations that are generated based on the insights described herein, provides senior developers with the ability to view additional information like the author of the source code and what portions of the source code were generated by an AI model. Implementations identify which code blocks of the source code being checked-in to a repository are AI-generated without modification. Implementations identify which code blocks of the source code being checked-in to a repository are AI-generated with modification by the user. Implementations identify which code blocks of the source code being checked-in to a repository are declined, such that all the AI-generated code was removed and rewritten by the user.

Implementations provide the ability to track statistics including but not limited to percentages of AI-generated code and human-generated code in a source code, as well as per-developer statistics for a user across plural different source codes for the user, the statistics showing respective measures across the plural different source codes of how much AI-generated code a user accepts without modification, how much AI-generated code a user accepts with modification, and how much AI-generated code a user declines.

Implementations provide management and governance capability for a senior developer to set thresholds and be alerted to coding guidelines they wish to understand. For example, when a first developer too frequently checks-in source code containing only AI-generated code without modification (which poses various risks described herein), or when a second developer too frequently checks-in source code containing no AI-generated code (which can be a measure of inefficiency). The identification of such thresholds enables the senior developer to follow-up on things to gain an understanding as to whether an engineer needs to have additional scrutiny and think through the implications of the code they are checking in.

Implementations provide management and governance capability such that a senior developer can compare code-blocks generated by different types of users (e.g., junior developer, senior developer, etc.) and determine implications of code they are checking-in. For example, a junior developer that too frequently checks-in source code containing AI-generated code without vetting it can result in a series of defects that can indicate that the quality of the code generation needs improvement. Another example is a component composition view that enables the management of the component to determine the percentage of the overall source code that is AI-generated versus human-generated, and to compare across multiple components to determine an optimal balance.

Implementations provide management and governance capability such that a senior developer can understand if their developers are never making use of AI models at all to gain development productivity.

Implementations provide management and governance capability such that a senior developer can understand when additional training data might be useful in specific component development areas. This may be based on comparing AI-generated code blocks within a component and defects occurring in those components. For example, in a cross-system comparison of AI-generated code included in source code(s) associated with a security component versus AI-generated code included in source code(s) associated with a records management component, the system may determine an insight that the AI-generated code associated with the records management component is causing 30% of the defects (e.g., problems) associated with the records management component, whereas the AI-generated code associated with the security component is causing 70% of the defects (e.g., problems) associated with the security component. Such insights may provide a senior developer with knowledge that AI-generated code works better for one type of component than another.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the AI-generated code governance code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

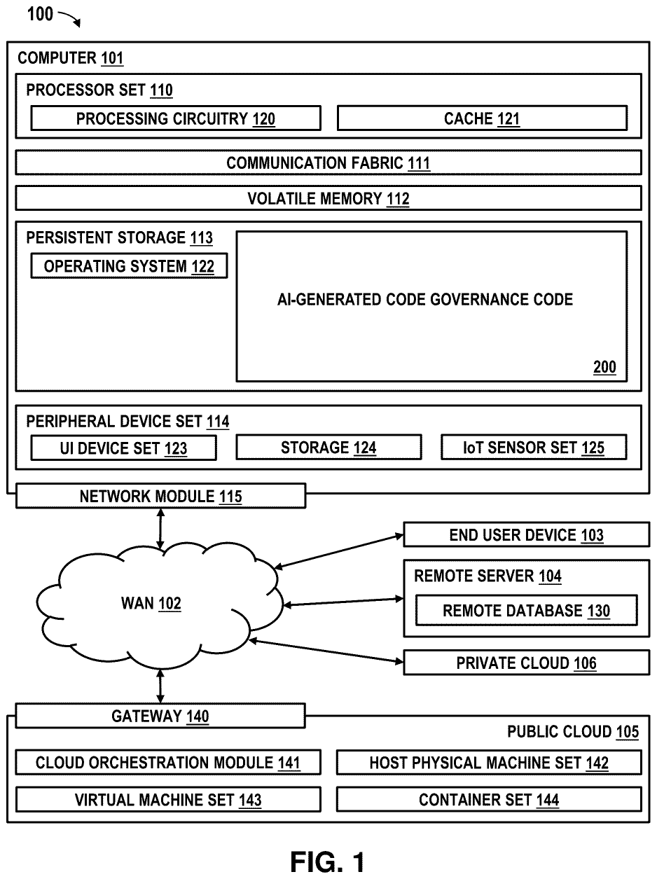

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

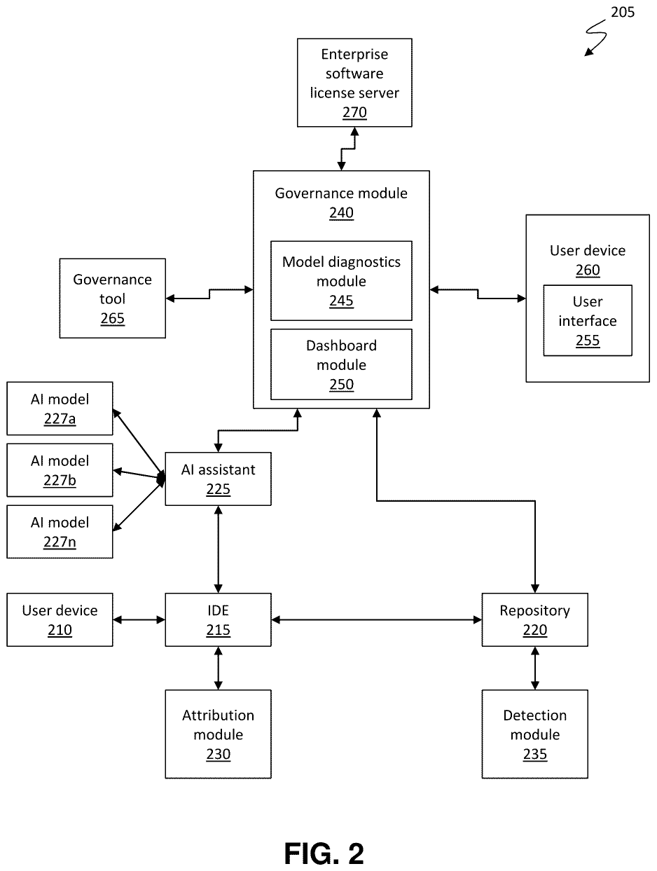

FIG. 2 shows a block diagram of an exemplary environment 205 in accordance with aspects of the invention. Communication between elements in the environment 205, which is represented by double-sided arrows, may be via one or more networks such as the WAN 102 of FIG. 1.

In embodiments, the environment 205 includes a user device 210 in communication with an integrated development environment (IDE) 215 so that a user may access the IDE 215 via the user device 210 to create (e.g., write) code such as source code. The user device 210 may comprise an instance of the EUD 103 of FIG. 1. The IDE 215 may comprise one or more instances of the remote server 104 of FIG. 1.

In various embodiments, the environment 205 includes a repository 220 that is configured to store code that is generated in the IDE 215. The repository 220 may comprise one or more instances of the remote server 104 of FIG. 1. In an example, the repository 220 comprises a source code management (SCM) repository, which is a source code repository that is configured to track changes to versions, and histories of versions, of respective instances of source code checked into the repository 220 by respective users of the IDE 215. In an exemplary implementation, source code created by a user in the IDE 215 is stored in the repository 220. In a versioning control example, a user may utilize a user interface of the IDE 215 displayed by the user device 210 to check out a version of their source code from the repository 220, revise the source code by making changes to the source code in the IDE 215, and then check in the revised version of the source code to the repository 220. In this manner, the repository 220 is configured to store versions of source code that are created by a user via the IDE 215.

Still referring to FIG. 2, and in various embodiments, the environment 205 includes an AI assistant 225 associated with the IDE 215. In accordance with aspects of the invention, a user utilizing the IDE 215 via the user device 210 may provide input to the IDE 215 that causes the AI assistant 225 to generate code using an AI model. The user may then accept, reject, or modify the code generated using the AI assistant 225 (also referred to as AI-generated code) for incorporation into source code the user is authoring in the IDE 215. In this manner, a user that is writing source code in the IDE 215 may leverage the AI assistant 225 to automatically generate code (e.g., a code snippet) that the user may include in their source code.

For example, the user device 210 may display a user interface of the IDE 215. In this example, the user interface permits the user to write code manually in the IDE 215, such as via typing. In this example, the user interface also includes an input field by which a user may enter a request for AI-generated code. For example, the input field may permit the user to enter (e.g., type or speak) a natural language request that describes code the user wants generated by the AI assistant 225. In response to this input from the user, the AI assistant 225 may use an AI model to automatically generate code based on the input. In this example, the IDE 215 receives the AI-generated code from the AI assistant 225 and presents (e.g., displays) the AI-generated code to the user, e.g., via the user interface of the IDE 215 displayed by the user device 210. In embodiments, after reviewing the AI-generated code in the user interface of the IDE 215, the user may provide input via the user interface of the IDE 215 to one of: (i) accept and incorporate the AI-generated code into their source code without making any modifications to the AI-generated code; (ii) reject the AI-generated code; or (iii) accept and incorporate the AI-generated code into their source code with user-made modifications to the AI-generated code. In this manner, the user may request AI-generated code via the IDE 215 and then incorporate the AI-generated code into their code that they are authoring in the IDE 215, either with or without modification to the AI-generated code.

Code that a user creates in the IDE 215 and stores in the repository 220 is referred to herein as a “source code” regardless of whether the code contains AI-generated code. As such, source code may include a code stored in the repository 220 that is 100% manually written by the user in the IDE 215 without any AI-generated code. Source code may also include a code stored in the repository 220 that is composed only of AI-generated code that was provided to the IDE 215 by the AI assistant 225. Source code may also include code stored in the repository 220 that includes some code that was manually written by the user in the IDE 215 and that includes some AI-generated code that was provided to the IDE 215 by the AI assistant 225.

With continued reference to the AI assistant of FIG. 2, in one example, the AI assistant 225 is programmed into the software of the IDE 215. In another example, the AI assistant 225 comprises a software extension or a plugin that adds functionality to the software of the IDE 215 without changing the software of the IDE 215. In another example, the AI assistant 225 comprises a web service or software-as-a-service (SaaS) that is accessed by the IDE 215 to add functionality to the IDE 215.

In embodiments, the AI assistant 225 communicates with one of plural different AI models 227a-n when generating code in response to a user request, where the number “n” of different models is any integer. Respective ones of the AI models 227a-n may be based on different respective LLMs.

In embodiments, the environment 205 of FIG. 2 comprises an attribution module 230, a detection module 235, and a governance module 240 including a model diagnostics module 245 and a dashboard module 250. Each of the modules may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of one or more instances of the computer 101 of FIG. 1, individually or in combination, to perform various operations of the inventive methods as described herein. The environment 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the attribution module 230 is configured to associate metadata with AI-generated code included in a source code that is created in the IDE 215. In embodiments, the metadata includes or is based on model information and/or licensing information associated with an AI model (e.g., one of AI models 227a-n) that was used to generate the AI-generated code. The model information may include, for example and without limitation, a model identifier (e.g., data that defines a name of an AI model that was used to generate the AI-generated code), model derivation information, and model tuning information. The licensing information may include, for example and without limitation, a name of a licensor of the license under which the AI-generated code was generated, and data that defines permissible and impermissible uses of code that is generated using the AI model that was used to generate the AI-generated code.

Still referring to the attribution module 230 of FIG. 2, in some embodiments the attribution module 230 obtains the model information and licensing information via the AI assistant 225. In one example, the AI assistant 225 stores respective model information and licensing information associated with the respective AI models 227a-n that the AI assistant 225 may use to generate the AI-generated code. In another example, the AI assistant 225 obtains model information and licensing information from a respective one of the AI models 227a-n when the AI assistant 225 uses the respective one of the AI models to generate the AI-generated code. In yet another example, the model diagnostics module 245 determines the model information and the licensing information and provides the model information and the licensing information to the AI assistant 225. In this example, when the AI assistant 225 uses a respective one of the AI models 227a-n to generate the AI-generated code, the model diagnostics module 245 queries a governance tool 265 to obtain the model information associated with the respective one of the AI models, and the model diagnostics module 245 queries an enterprise software license server 270 to obtain the licensing information for the respective one of the AI models. In this example, the governance tool 265 is a tool that is configured to monitor usage of AI models used by an enterprise and includes respective model information about respective ones of the AI models used by the enterprise (e.g., model card with information about how a respective ones of the AI models was trained). In this example, the enterprise software license server 270 stores information about respective software licenses defined for software used by the enterprise (e.g., details about which software licenses an enterprise has purchased, including licensors, and permissions and limitations associated with the licenses), including respective AI models used by the enterprise.

In some embodiments, the attribution module 230 obtains the model information and licensing information and associates the metadata with portions of the source code that include the AI-generated code. In implementations, the IDE 215 includes metadata that defines lines of code, an author associated with each line of code, and a timestamp associated with each line of code. The lines of code may be defined by line numbers. The author of a line of code may be defined as the user that is logged into the IDE 215 when the line of code is created or revised. The timestamp for a line of code may be defined as the time when the line of code was created or revised. In embodiments, the attribution module 230 associates the AI model metadata (e.g., the model information and license information) with each line of code that is AI-generated code, e.g., code that is provided to the IDE 215 by the AI assistant 225. In this manner, a source code that is created in the IDE 215 and stored in the repository 220 may have metadata that defines: lines of the source code; an author associated with each line of the source code; a timestamp associated with each line of the source code; model information and license information for each line of the source code that includes AI-generated code. For each line of the source code that includes the AI-generated code, the metadata associated with the source code may also include an indication of whether the AI-generated code was modified or not modified when incorporated into the source code.

In some embodiments, the attribution module 230 sends data to the IDE 215 that causes the IDE 215 to display information in real-time in the user interface of the user device 210. The information may be displayed in real-time to a user working on the code file of their source code in the user interface. The information may include (e.g., show), for a respective block of the code, who authored the block (e.g., developer name, AI authorship, AI model factsheet information, and whether the AI-generated code was accepted with or without modification).

In accordance with aspects of the invention, the detection module 235 is configured to detect AI-generated code included in the source code that is stored in the repository 220, and to associate metadata with the detected AI-generated code. In some embodiments, the source code that is created in the IDE 215 does not include any AI model metadata (e.g., model information and license information) when the source code is stored in the repository 220. This can be the case when the source code was created in the IDE 215 without using the AI assistant 225. This can also be the case when the source code created in the IDE 215 includes AI-generated code but the AI model metadata (e.g., model information and license information) was not included with the source code when the source code was stored in the repository 220. In such cases, the detection module 235 is configured to detect AI-generated code included in the source code and to associate metadata with the detected AI-generated code.

In embodiments, the detection module 235 detects AI-generated code included in the source code by using a combination of pattern analysis and perplexity analysis to determine whether a portion of the source code is AI-generated code. Pattern analysis seeks recurring structures, sequences, or regularities embedded within the text of the source code. Pattern analysis may be accomplished through chunk-wise classification methods that pertain to identifying recurring patterns within the text of the source code. Perplexity analysis is based on depicting language unpredictability in an input text. Increased perplexity indicates a higher likelihood that the input text deviates from the expected characteristics of a pre-trained model architecture. Conversely, diminished perplexity denotes an enhanced fit, signifying that the model aligns well with the text's anticipated patterns. If a text's perplexity closely matches predictions made by an AI model, then it serves as an indicator that the text may have originated from AI. In embodiments, the detection module 235 is programmed to perform pattern analysis and perplexity analysis on portions of the source code, and to output a score for the portion of code being analyzed. The score may be on a continuum between real (e.g., 100% human-generated content) and fake (e.g., 100% AI-generated content). In one example, a threshold is defined and for a portion of text of the source code whose score is above the threshold, the detection module 235 deems that portion of text as being human-generated code. In this example, for a portion of text of the source code whose score is below the threshold, the detection module 235 deems that portion of text as being AI-generated code. In another example, a first threshold and a second threshold are defined. In this example, for a portion of text of the source code whose score is above the first threshold, the detection module 235 deems that portion of text as being human-generated code. In this example, for a portion of text of the source code whose score is below the second threshold, the detection module 235 deems that portion of text as being AI-generated code. In this example, for a portion of text of the source code whose score is below the first threshold and above the second threshold, the detection module 235 deems that portion of text as being a hybrid of human-generated code and AI-generated code.

In accordance with further aspects of the invention, based on detecting AI-generated code in the source code, the detection module 235 is configured to identify an AI model that generated the AI-generated code. In one example, the detection module 235 comprises a machine-learning model that is trained to detect patterns in AI-generated code, wherein respective ones of the patterns are associated with respective ones of AI models that generate code. In one example, the detection module 235 comprises code that is configured to identify a watermark identifier in the AI-generated code, wherein different respective watermark identifiers are associated with different respective ones of AI models that generate code. In an even further example, the detection module 235 may be configured to identify an AI model that generated the AI-generated code using a combination of the machine-learning model that is trained to detect patterns in AI-generated code and watermark identification methods. In this manner, in each of these examples, the detection module 235 may be used to detect AI-generated code that is present in a source code in the repository 220, and to identify an AI model that generated the detected AI-generated code.

In accordance with further aspects of the invention, based on identifying an AI model that generated the detected AI-generated code, the detection module 235 is configured to obtain model information and license information associated with the identified AI model. In embodiments, the detection module 235 queries the model diagnostics module 245 to obtain the model information and license information associated with the identified AI model. The model diagnostics module 245 queries the governance tool 265 to obtain the model information associated with the identified AI model, and the diagnostics module 245 queries the enterprise software license server 270 to obtain the licensing information associated with the identified AI model.

In accordance with further aspects of the invention, based on obtaining the AI model metadata (e.g., the model information and license information) associated with the identified AI model, the detection module 235 is configured to associate the AI model metadata with each line of code that was detected as AI-generated code. In this manner, a source code that is stored in the repository 220 may have metadata that defines: lines of the source code; an author associated with each line of the source code; a timestamp associated with each line of the source code; model information and license information for each line of the source code that includes AI-generated code. For each line of the source code, the metadata may indicate whether the line is human generated, AI-generated, or a hybrid of human and AI generated.

In accordance with aspects of the invention, the governance module 240 is configured to generate insights by analyzing the metadata associated with the AI-generated code included in the source code in the repository 220 and generate dashboard visualizations that are based on the insights and that are configured to be displayed in a user interface 255 of a user device 260. In embodiments, the model diagnostics module 245 is configured to determine the insights by analyzing the source code, from the repository 220, and its associated metadata (e.g., lines of the source code, an author associated with each line of the source code, a timestamp associated with each line of the source code, model information and license information for each line of the source code that includes AI-generated code, and an indication of whether the AI-generated code was modified or not modified for each line of the source code that includes the AI-generated code). In embodiments, the insights are based on analyzing the metadata associated with the source code to determine a percentage of the source code that is AI-generated code versus human-generated code, an identification of one or more of the AI models 227a-n used to generate the AI-generated code, and licensing information associated with the one or more of the AI models 227a-n used to generate the AI-generated code.

In embodiments, the dashboard module 250 is configured to generate the visualizations based on the insights determined by the model diagnostics module 245. In various embodiments, the dashboard module 250 receives user input from the user interface 255, triggers the model diagnostics module 245 based on this user input to determine an insight based on a source code and its associated metadata, and generates a visualization for display in the user interface 255 based on the insight determined by the model diagnostics module 245. In one example, the dashboard module 250 generates a visualization that includes a time series that shows the proportions of AI-generated code and human-generated code in the source code over time. In another example, the dashboard module 250 generates a visualization that includes a histogram that shows the proportions of AI-generated code and human-generated code in the source code at a single point in time. In another example, the dashboard module 250 generates a visualization that includes a chart showing a composition of software licenses associated with AI-generated code in the source code. These examples are not limiting, and the dashboard module 250 may generate other visualizations based on the determined insights.

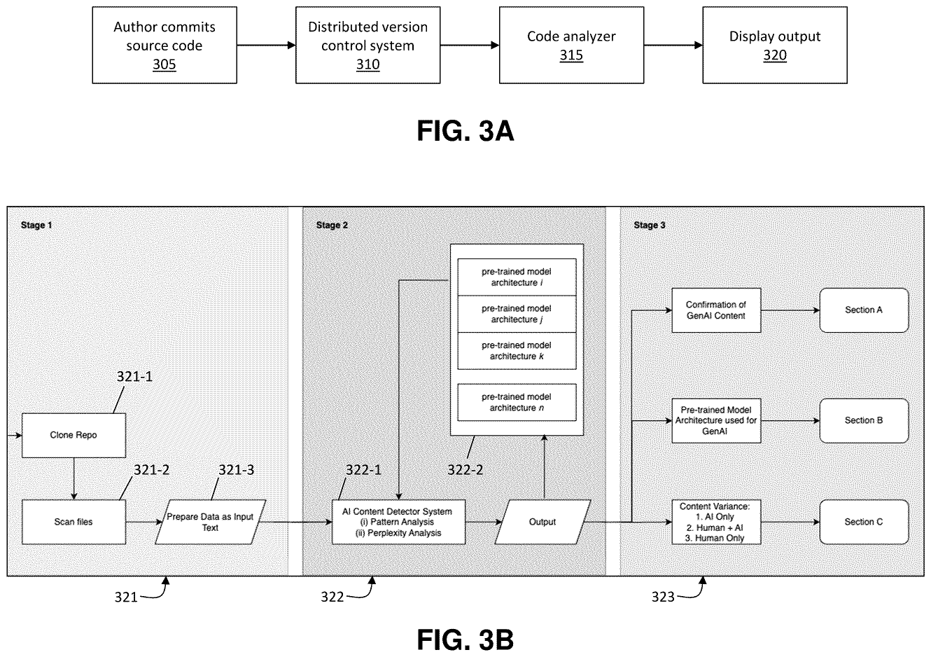

FIGS. 3A and 3B show flowcharts illustrating an exemplary method in accordance with aspects of the present invention. Steps of the method may be carried out in the environment of FIG. 2 and are described with reference to elements depicted in FIG. 2.

In some situations, a source code stored in the repository 220 does not include metadata associated with AI-generated portions of the code. In these situations, the detection module 235 may be used to analyze the source code for AI-generated code and associate metadata with the source code based on detecting AI-generated code. As shown in FIG. 3A, step 305 comprises the user creating their source code in the IDE 215 and committing the source code to the repository 220. At step 310, the committed source code is checked-in to a distributed version control system that manages files stored in the repository 220. At step 315, the detection module 235 calculates the proportion of the source code that is human-generated compared to AI-generated, assesses the extent to which the AI-generated code recommendations were modified by the human user via the IDE 215 prior to the source code being committed, and identifies the base AI model(s) used for generating the AI-generated code that is in the source code. At step 320, an output is displayed in human readable format.

Blocks 321, 323, and 323 of FIG. 3B represent stages involved in step 315 of FIG. 3A. In embodiments, steps shown in FIG. 3B are performed by the detection module 235, although one or more operations of such steps may alternatively be performed by other modules such as the model diagnostics module 245.

In a first stage (block 321), the source code is cloned from the repository 220 (step 321-1), scanned (step 321-2), and prepared as input text (step 321-3). In this first stage, the repository data (i.e., the source code) is replicated in an isolated environment designated for code analysis. Programming language files, encompassing .java, .py, .yaml, are extracted and transitioned into the input text.

In a second stage (block 322), the input text from the first stage is crossed over to a dedicated system that is designed for detecting AI-generated code. In embodiments, and as described with respect to FIG. 2, the system uses pattern analysis and perplexity analysis to detect AI-generated code in the source code (step 322-1). The pattern analysis and perplexity analysis may be based on respective pretrained model architectures (block 322-2) designed for respective ones of the AI models 227a-n. The system can additionally or alternatively detect AI-generated code in the source code via watermark identifiers associated with AI models.

A third stage (block 323) represents a data aggregation stage in which outcomes derived from the analyses in the second stage are consolidated. The third stage represents the juncture of synthesis where patterns and perplexities studied in the second stage merge to form a comprehensive understanding. These empirical findings come together to form a clear narrative, prepared for sharing. The resulting synthesis signifies a process of refining, taking data aggregation from simple compilation to organized insights into these three distinctive sections highlighted in the Table 1.

TABLE 1

| Section | Display |
|---|---|
| A | Provides an indication if the source code is flagged as |
| | AI-generated code, e.g., red indicates No, and green |
| | indicates as Yes |
| B | Provides an indication of the pre-trained model |
| | architecture (AI model) used to generate the AI- |
| | generated code |
| C | Provides an indication of the possible input source code |
| | i. AI only |
| | ii. AI + Human |
| | iii. Human Only |

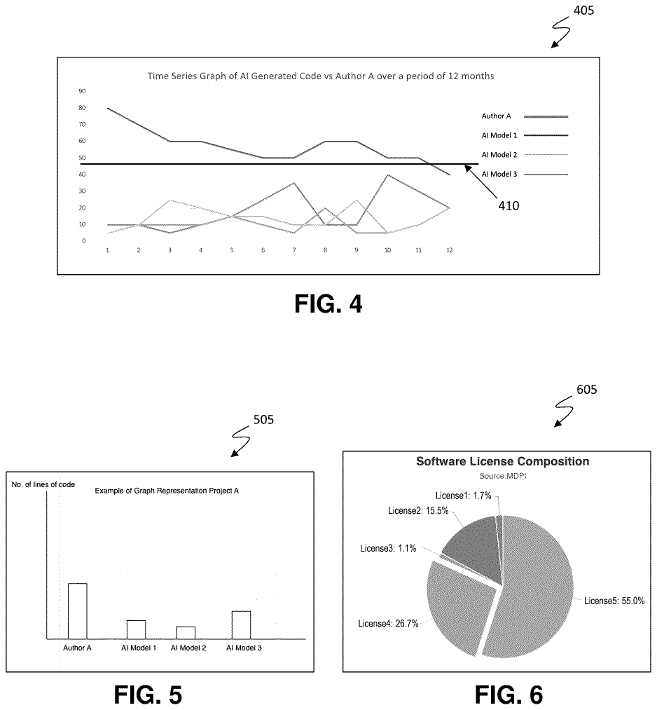

FIG. 4 shows an exemplary visualization 405 generated in the environment 205 of FIG. 2 in accordance with aspects of the invention. In the example shown in FIG. 4, the visualization 405 is generated by the dashboard module 250 of FIG. 2 based on insights determined by the model diagnostics module 245 analysis of a source code, from the repository 220, and its associated metadata. The visualization 405 may be displayed via the user interface 255 of FIG. 2. The visualization 405 includes a time series that shows proportions of AI-generated code and human-generated code in the source code over time. The proportions are measured on the vertical axis (e.g., as percentage of the source code) and time is measured on the horizontal axis. In this example, the percentage of the human-generated code in the source code is shown by the line labeled “Author A.” In this example, the percentage of AI-generated code that is in the source code and that was generated by AI model 227a is shown by the line labeled “AI Model 1”. In this example, the percentage of AI-generated code that is in the source code and that was generated by AI model 227b is shown by the line labeled “AI Model 2”. In this example, the percentage of AI-generated code that is in the source code and that was generated by AI model 227n is shown by the line labeled “AI Model 3”. This visualization 405 provides a user (e.g., a senior developer) with valuable information about the changing proportions of AI-generated code and human-generated code in the source code over a period of time. In one example, the user provides input to the user interface 255 to request the visualization, and the dashboard module 250 generates the visualization 405 based on the request. The request may specify the amount of time shown in the time series (e.g., 12 months in the example shown in FIG. 4).

With continued reference to FIG. 4, in some embodiments the dashboard module 250 is configured to generate the visualization 405 to include a visual indication 410 of a threshold value. The threshold value may be a user-defined value, such as a relative percentage of the source code. The visual indication 410 provides the user viewing the visualization 405 with a reference that indicates the percentage of human-generated code in the source code has dropped below the threshold value associated with the visual indication 410, which may assist the reviewing user in making governance decisions for risk management.

In further embodiments, the dashboard module 250 may be configured to generate an alert when such a threshold is crossed. In one example, the threshold is a minimum threshold for the percentage of human-generated code in the source code, and the system sends an alert to a designated user based on the percentage of human-generated code in the source code dropping below the threshold value. In another example, the threshold is a maximum threshold for the percentage of all AI-generated code in the source code, and the system sends an alert to a designated user based on the percentage of all AI-generated code in the source code exceeding the threshold value. In another example, the threshold is a maximum threshold for the percentage of AI-generated code, from a respective one of the AI models 227a-n, in the source code, and the system sends an alert to a designated user based on the percentage of all AI-generated code for this one of the models exceeding the threshold value. Different respective thresholds may be set for different respective ones of the AI models 227a-n.

In some embodiments, the model diagnostics module 245 is configured to determine a correlation between AI-generated code in the source code and a number of problems associated with the AI-generated code. In embodiments, the model diagnostics module 245 communicates with a problem tracking system of the enterprise and obtains data about problems that are observed and/or reported for the source code. Such problems may include crashes, bugs, etc., and may be determined from data such as logs, metrics, traces, help desk tickets, etc. In embodiments, the system is configured to generate an alert and/or adjust the threshold associated with a respective one of the AI models 227a-n in response to the number of problems associated with AI-generated code generated by this AI model exceeding a problem threshold. For example, if the maximum threshold for the percentage of AI-generated code from AI model 227a is 30%, and if the problem threshold is 3 problems, then the model diagnostics module 245 may adjust the percentage of AI-generated code from AI model 227a downward to 20% based on a determination that 5 problems (from the problem tracking system) are associated with the AI-generated code from AI model 227a. In this example, the dashboard module 250 may also generate an alert based on a determination the 5 problems associated with the AI-generated code from AI model 227a exceeds the problem threshold of 3 problems.

As illustrated by FIGS. 2 and 4, systems and methods according to aspects of the invention provide the ability to compare the evolution of AI-generated code versus human-authored code in a source code over a period of time. In embodiments, the systems and methods include: a data storage component for storing time-stamped code snapshots generated by both AI and human authors; a graphical user interface component for displaying a time series graph of the code snapshots, wherein the graph illustrates the changes and differences between the AI-generated code and human-authored code over time; a processing component for analyzing the time series data and identifying patterns, trends, and anomalies in the evolution of the code; and a reporting component for generating summaries and visualizations of the analysis results, the summaries and visualizations being suitable for use in intellectual property decision-making.

FIG. 5 shows an exemplary visualization 505 generated in the environment 205 of FIG. 2 in accordance with aspects of the invention. In the example shown in FIG. 5, the visualization 505 is generated by the dashboard module 250 of FIG. 2 based on insights determined by the model diagnostics module 245 analysis of a source code, from the repository 220, and its associated metadata. The visualization 505 may be displayed via the user interface 255 of FIG. 2. The visualization 505 includes a histogram that shows the proportions of AI-generated code and human-generated code in the source code at a single point in time. The proportions are measured on the vertical axis (e.g., as number of lines of the source code) and different contributors are shown along the horizontal axis. In this example, the proportion of the human-generated code in the source code is shown by the rectangle labeled “Author A.” In this example, the proportion of AI-generated code that is in the source code and that was generated by AI model 227a is shown by the rectangle labeled “AI Model 1”. In this example, the proportion of AI-generated code that is in the source code and that was generated by AI model 227b is shown by the rectangle labeled “AI Model 2”. In this example, the proportion of AI-generated code that is in the source code and that was generated by AI model 227n is shown by the rectangle labeled “AI Model 3”. This visualization 505 provides a user (e.g., a senior developer) with valuable information about the current proportions of AI-generated code and human-generated code in the source code. In embodiments, the user provides input to the user interface 255 to request the visualization 505, and the dashboard module 250 generates the visualization 505 based on the user input. In one example, the user input comprises the user hovering a mouse cursor over the source code in the user interface 255, and the visualization 505 is displayed in a pop-up window or overlay in the user interface 255 in real-time as the user hovers the cursor over the source code.

As illustrated by FIGS. 2 and 5, systems and methods according to aspects of the invention provide the ability to visualize the composition of a project's source code contribution between human authors and AI models. In embodiments, the systems and methods include: a data processing component for analyzing the source code and identifying the contributions made by human authors and AI models; a data visualization component for generating a histogram chart that illustrates the composition of the source code contribution between human authors and AI models; a user interface component for displaying the histogram chart in a way that is easily understandable by a user, the user interface component allowing the user to interact with the chart and explore the data in more detail; a filtering component for allowing the user to filter the data based on specific criteria, such as date range, code module, or author; and a reporting component for generating summaries and visualizations of the data, said summaries and visualizations being suitable for use in project management, code review, and intellectual property decision-making.

FIG. 6 shows an exemplary visualization 605 generated in the environment 205 of FIG. 2 in accordance with aspects of the invention. In the example shown in FIG. 6, the visualization 605 is generated by the dashboard module 250 of FIG. 2 based on insights determined by the model diagnostics module 245 analysis of a source code, from the repository 220, and its associated metadata. The visualization 605 may be displayed via the user interface 255 of FIG. 2. The visualization 605 includes a chart showing the composition of software licenses associated with AI-generated code in the source code. The chart is a pie chart, and the proportions are shown by respective areas of the pie chart. In this example, the visualization 605 shows relative proportions of the source code that are associated with respective ones of licenses named License1, License2, License3, License4, and License5. This visualization 605 provides a user (e.g., a business manager, legal consultant, etc.) with valuable information about licenses that affect the source code. In embodiments, the user provides input to the user interface 255 to request the visualization 605, and the dashboard module 250 generates the visualization 605 based on the user input. In one example, the user input comprises the user hovering a mouse cursor over the source code in the user interface 255, and the visualization 605 is displayed in a pop-up window or overlay in the user interface 255 in real-time as the user hovers the cursor over the source code.

As illustrated by FIGS. 2 and 6, systems and methods according to aspects of the invention provide the ability to analyze and visualize the composition of software licenses in AI-generated code. In embodiments, the systems and methods include: a data processing component for identifying and extracting license information from the AI-generated code; a data classification component for categorizing the licenses into different categories, such as by license name; a data visualization component for generating a graphical representation of the license composition, wherein graphical representation illustrates the proportion of each license category in the AI-generated code; a user interface component for displaying the graphical representation in a way is easily understandable by a user, the user interface component allowing the user to interact with the graphical representation and explore the data in more detail; a filtering component for allowing the user to filter the data based on specific criteria, such as license category, code module, or author; and a reporting component for generating summaries and visualizations of the data, the summaries and visualizations being suitable for use in intellectual property management, compliance monitoring, and software development decision-making

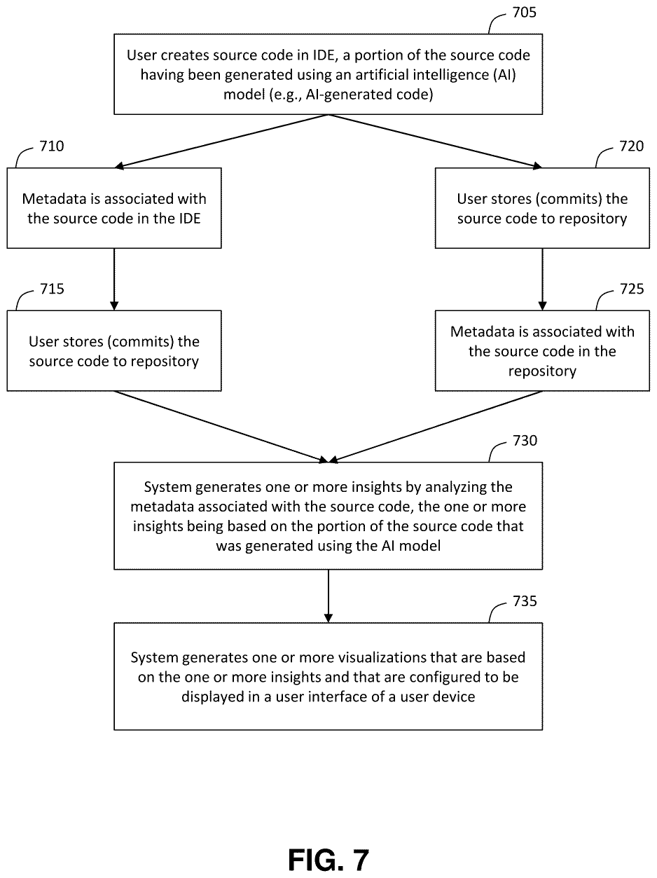

FIG. 7 shows a flowchart of an exemplary method in accordance with aspects of the present invention. Steps of the method may be carried out in the environment of FIG. 2 and are described with reference to elements depicted in FIG. 2.

At step 705 a user creates source code in IDE, a portion of the source code having been generated using an artificial intelligence (AI) model (e.g., AI-generated code). In embodiments, and as described with respect to FIG. 2, the user utilizes the user device 210 to access the IDE 215. While writing the source code in the IDE 215, the user prompts the IDE for AI-generated code, which is supplied to the IDE 215 by the AI assistant 225. The user elects to accept the AI-generated code into the source code without modification, accepts the AI-generated code into the source code with modification, or denies the AI-generated code.

In one embodiment, at step 710 metadata is associated with the source code in the IDE. In embodiments, and as described with respect to FIG. 2, the attribution module 230 associates model information and license information with the source code for portions of the source code that are AI-generated code. In this embodiment, at step 715 the user stores the source code in the repository 220. In embodiments, and as described with respect to FIG. 2, the user utilizes the IDE 215 to commit the source code to a version control system of the repository 220.

In another embodiment, at step 720 the user stores the source code in the repository 220. In embodiments, and as described with respect to FIG. 2, the user utilizes the IDE 215 to commit the source code to a version control system of the repository 220. In this embodiment, at step 725 the system associates metadata with the source code in the repository 220. In embodiments, and as described with respect to FIG. 2, the detection module 235 detects the AI-generated code in the source code and associates the metadata with the source code based on this detection.

In both embodiments, at step 730 the system generates one or more insights by analyzing the metadata associated with the source code, the one or more insights being based on the portion of the source code that was generated using the AI model. In embodiments, and as described with respect to FIG. 2, the model diagnostics module 245 generates the insights.

At step 735 the system generates one or more visualizations that are based on the one or more insights and that are configured to be displayed in a user interface of a user device. In embodiments, and as described with respect to FIG. 2, the dashboard module 250 generates the dashboard visualizations.

In some embodiments of the method, the metadata is associated with the source code at the IDE 215 and before the source code has been deposited in the repository 220. In one example, the metadata comprises model information and license information that is determined by an AI assistant associated with the IDE. In another example, the metadata comprises model information and license information that is determined from enterprise tools that are external to the IDE (e.g., the governance tool 265 and the enterprise software license server 270).

In some embodiments of the method, the metadata is associated with the source code after the source code has been deposited in the repository 220 after having been created in the IDE 215. In these embodiments, the method may further comprise detecting the portion of the source code that was generated using the AI model, and associating the metadata with the source code based on the detecting.

In some embodiments of the method, the one or more insights comprise one or more selected from a group consisting of: a determination of a first proportion of the source code written by a human user; a determination of a second proportion of the source code generated by the AI model; and a determination of respective proportions of the source code that are associated with respective ones of different licenses.

In some embodiments of the method, the one or more dashboard visualizations comprise a time series showing a proportion of the source code written by a human and a proportion of the source code generated by the AI model over plural points in time, e.g., as shown at FIG. 4.

In some embodiments of the method, the one or more dashboard visualizations comprise a histogram showing an amount of the source code written by a human and an amount of the source code generated by the AI model at a single point in time, e.g., as shown in FIG. 5.

In some embodiments of the method, the one or more dashboard visualizations comprise a chart showing respective proportions of the portion of the source code that are associated with respective licenses, e.g., as shown in FIG. 6.

In some embodiments of the method, the metadata comprises model information associated with the AI model that was used to generate the portion of the source code, the model information including one or more selected from a group consisting of: a model identifier; model derivation information; and model tuning information.

In some embodiments of the method, the AI model comprises a first AI model, and the one or more insights are further based on one or more others portion of the source code generated using one or more other AI models different than the first AI model.

In some embodiments of the method, the generating of one or more dashboard visualizations is performed in response to receiving a user input via the user interface. The user input may comprise hovering a cursor over a line of the source code in the user interface or selecting a subset of the source code in the user interface using a keyboard, mouse, or touchscreen input.

In some embodiments of the method, the one or more dashboard visualizations include a visual indication of a threshold value. The threshold value may be associated with an amount of the source code generated by a human user. The threshold value may be associated with an amount of the source code generated by the AI model. In some embodiments, the method further comprises: correlating the portion of the source code that was generated using the AI model with a number of problems associated with the code; and adjusting the threshold value based on the correlating.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating one or more insights by analyzing metadata associated with a source code that has been deposited in a repository, the one or more insights being based on a portion of the source code that was generated using an artificial intelligence (AI) model; and
generating one or more visualizations that are based on the one or more insights and that are configured to be displayed in a user interface of a user device.

2. The computer implemented method of claim 1, wherein the metadata is associated with the source code at an integrated development environment (IDE) and before the source code has been deposited in the repository.

3. The computer implemented method of claim 2, wherein the metadata comprises model information and license information that is determined by an AI assistant associated with the IDE.

4. The computer implemented method of claim 2, wherein the metadata comprises model information and license information that is determined from enterprise tools that are external to the IDE.

5. The computer implemented method of claim 1, wherein the metadata is associated with the source code after the source code has been deposited in the repository after having been created in an integrated development environment (IDE).

6. The computer implemented method of claim 5, further comprising:
detecting the portion of the source code that was generated using the AI model; and
associating the metadata with the source code based on the detecting.

7. The computer implemented method of claim 1, wherein the one or more insights comprise one or more selected from a group consisting of:
a determination of a first proportion of the source code written by a human user;
a determination of a second proportion of the source code generated by the AI model; and
a determination of respective proportions of the source code that are associated with respective ones of different licenses.

8. The computer implemented method of claim 1, wherein the one or more dashboard visualizations comprise a time series showing a proportion of the source code written by a human and a proportion of the source code generated by the AI model over plural points in time.

9. The computer implemented method of claim 1, wherein the one or more dashboard visualizations comprise a histogram showing an amount of the source code written by a human and an amount of the source code generated by the AI model at a single point in time.

10. The computer implemented method of claim 1, wherein the one or more dashboard visualizations comprise a chart showing respective proportions of the portion of the source code that are associated with respective licenses.

11. The computer implemented method of claim 1, wherein the metadata comprises model information associated with the AI model that was used to generate the portion of the source code, the model information including one or more selected from a group consisting of: a model identifier; model derivation information; and model tuning information.

12. The computer implemented method of claim 1, wherein:
the AI model comprises a first AI model; and
the one or more insights are further based on one or more others portion of the source code generated using one or more other AI models different than the first AI model.

13. The computer implemented method of claim 1, wherein the generating the one or more dashboard visualizations is performed in response to receiving a user input via the user interface.

14. The computer implemented method of claim 13, wherein the user input comprises hovering a cursor over a line of the source code in the user interface or selecting a subset of the source code in the user interface using a keyboard, mouse, or touchscreen input.

15. The computer implemented method of claim 1, wherein the one or more dashboard visualizations include a visual indication of a threshold value.

16. The computer implemented method of claim 15, wherein the threshold value is associated with an amount of the source code generated by a human user.

17. The computer implemented method of claim 15, wherein the threshold value is associated with an amount of the source code generated by the AI model.

18. The computer implemented method of claim 15, further comprising:
correlating the portion of the source code that was generated using the AI model with a number of problems associated with the code; and
adjusting the threshold value based on the correlating.

19. A computer program product comprising:
one or more computer-readable storage media; and
program instructions stored on the one or more computer-readable storage media to perform operations comprising:
generating one or more insights by analyzing metadata associated with source code that has been deposited in a repository, the one or more insights being based on one or more portions of the source code that were generated using one or more different artificial intelligence (AI) models, the metadata having been associated with the source code in an integrated development environment (IDE); and
generating one or more dashboard visualizations that are based on the one or more insights and that are configured to be displayed in a user interface of a user device.

20. A computer system comprising:
a processor set;
one or more computer-readable storage media; and
program instructions stored on the one or more computer-readable storage media to cause the processor set to perform operations comprising:
detecting one or more portions of source code that were generated using one or more different artificial intelligence (AI) models;
associating metadata with the source code based on the detecting;
generating one or more insights by analyzing the metadata, the one or more insights being based on the one or more portions of source code that were generated using the one or more different artificial intelligence (AI) models; and
generating one or more dashboard visualizations that are based on the one or more insights and that are configured to be displayed in a user interface of a user device.
